(19) United States
(12) Patent Application Publication
(10) Pub. No.: US 2025/0278116 A1
(43) Pub. Date: Sep. 4, 2025

(54) JOINT ASSEMBLY FOR AN EXTENDED-REALITY HEADSET, AND SYSTEMS AND METHODS OF USE THEREOF

(71) Applicant: Meta Platforms Technologies, LLC, Menlo Park, CA (US)

(72) Inventors: Christopher Soo-Hoo, San Francisco, CA (US); Francisco De La Paz, Fremont, CA (US)

(21) Appl. No.: 19/054,650

(22) Filed: Feb. 14, 2025

Related U.S. Application Data
(60) Provisional application No. 63/561,268, filed on Mar. 4, 2024.

(51) Int. Cl. G06F 1/16; F16C 11/04; G02B 27/01

(52) U.S. Cl. CPC G06F 1/163; F16C 11/04; G02B 27/0176; G02B 2027/0154; G02B 2027/0178

(57) ABSTRACT

An extended-reality headset with a joint assembly that includes a first ring, a second ring, and a concentric ring is described. The first ring is a rigid ring connected to an arm of the extended-reality headset. The second ring is a rigid ring connected to a main body of the extended-reality headset. The connecting ring is a flexible ring that couples the first ring to the second ring and allows the arm and the main body to move relative to each other in at least two degrees of freedom.

### RELATED APPLICATION

This application claims priority to U.S. Provisional Application Ser. No. 63/561,268 filed Mar. 4, 2024, which is hereby incorporated by reference in its entirety.

### TECHNICAL FIELD

This relates generally to extended-reality headsets (e.g., virtual-reality headsets and/or augmented reality headsets), including techniques for orienting straps relative to the body of an extended-reality headset such that the extended reality headset fits comfortably on different wearers with a wide range of head sizes and facial structures.

### BACKGROUND

Users of extended-reality headsets can become substantially immersed in the extended-reality environment, which can be conducive to a richer, more engaging user experience. However, one drawback to existing extended-reality wearable devices is that users with below-average and above-average head sizes experience discomfort due to the extended-reality headsets not fitting properly. Being uncomfortable while wearing the extended-reality headsets can impair the users' immersion in the extended-reality environment and limit the amount of time users can spend in the extended-reality environment.

Techniques for making the extended-reality headsets fit users with different head sizes exist but do not make the extended-reality headsets fit users comfortably. Accordingly, there is a need for more accurate techniques.

As such, there is a need to address one or more of the above-identified challenges. A brief summary of solutions to the issues noted above are described below.

### SUMMARY

The devices described herein allow users wearing extended-reality headsets to engage with an extended-reality environment in an immersive and interactive manner by minimizing the discomfort experienced while wearing the wearable devices. Connecting the main body of the extended-reality wearable device to the arms of the extended-reality wearable device with a joint assembly that includes a flexible member allows for a greater range of motion between the main body and the arms of the extended-reality wearable device. This greater range of motion (e.g., movement in multiple degrees of freedom) allows for the extended-reality headsets to adopt a wider range of orientations to fit a wider range of head sizes and shapes.

One example of an extended-reality headset is described herein. This example extended-reality headset includes a joint assembly that includes a first ring, a second ring, and a connecting ring that couples the first ring to the second ring. The first ring is connected to an arm of the extended-reality headset. The second ring is connected to a main body of the extended-reality headset. The connecting ring comprises a flexible material such that the first ring and the second ring can remain coupled and move relative to each other. The connecting ring is configured to enable movement along a first degree of freedom of the arm of the extended-reality headset relative to the main body of the extended reality headset, and the connecting ring is also configured to enable movement along a second degree of freedom of the arm of the extended reality headset relative to the main body of the extended reality headset, and the first degree of freedom is different from the second degree of freedom.

In some embodiments, the joint assembly is configured to have a first orientation when donned upon a first-sized head, and the first orientation includes a first measurement along the first degree of freedom and a first measurement along the second degree of freedom. In some embodiments, the joint assembly is also configured to have a second orientation when donned upon second-sized head, that is different in size than the first-sized head, and the second orientation includes a second measurement along the first degree of freedom and a second measurement along the second degree of freedom.

In some embodiments, the first ring and the second ring are constructed of a first material that is more rigid than a second material of the connecting ring, such that the second material can compress and stretch while being worn by a wearer. In some embodiments, the connecting ring is constructed of rubber. In some embodiments, the first ring and the second ring are constructed of plastic.

Having summarized the first aspect generally related to use of an extended-reality headset with a joint assembly with a concentric ring design above, an example of a hinge for an extended-reality headset and an extended-reality system with an extended-reality headset incorporating the previously described joint assembly are also described herein.

The features and advantages described in the specification are not necessarily all inclusive and, in particular, certain additional features and advantages will be apparent to one of ordinary skill in the art in view of the drawings, specification, and claims. Moreover, it should be noted that the language used in the specification has been principally selected for readability and instructional purposes.

Having summarized the above example aspects, a brief description of the drawings will now be presented.

### BRIEF DESCRIPTION OF THE DRAWINGS

For a better understanding of the various described embodiments, reference should be made to the Detailed Description below, in conjunction with the following drawings in which like reference numerals refer to corresponding parts throughout the figures.

FIGS. 1A and 1B illustrate an extended-reality headset with the joint assembly of the extended-reality headset positioned to fit a wearer with a head size in the fifth percentile and the ninety-fifth percentile, respectively, in accordance with some embodiments.

FIGS. 2A and 2B illustrate an extended-reality headset with the arms rotating clockwise and counter-clockwise, respectively, in accordance with some embodiments.

FIG. 3 illustrates the structure of the joint assembly, in accordance with some embodiments.

FIGS. 4A, 4B, 4B-1, and 4B-2 illustrate example artificial-reality systems, in accordance with some embodiments.

FIGS. 5A, 5B-1, 5B-2, and 5C illustrate example head-wearable devices, in accordance with some embodiments.

In accordance with common practice, the various features illustrated in the drawings may not be drawn to scale. Accordingly, the dimensions of the various features may be arbitrarily expanded or reduced for clarity. In addition, some of the drawings may not depict all of the components of a given system, method, or device. Finally, like reference numerals may be used to denote like features throughout the specification and figures.

### DETAILED DESCRIPTION

Numerous details are described herein to provide a thorough understanding of the example embodiments illustrated in the accompanying drawings. However, some embodiments may be practiced without many of the specific details, and the scope of the claims is only limited by those features and aspects specifically recited in the claims. Furthermore, well-known processes, components, and materials have not necessarily been described in exhaustive detail so as to avoid obscuring pertinent aspects of the embodiments described herein.

Embodiments of this disclosure can include or be implemented in conjunction with various types or embodiments of artificial-reality systems. Artificial-reality (AR), as described herein, is any superimposed functionality and or sensory-detectable presentation provided by an artificial-reality system within a user's physical surroundings. Such artificial-realities can include and/or represent virtual reality (VR), augmented reality, mixed artificial-reality (MAR), or some combination and/or variation one of these. For example, a user can perform a swiping in-air hand gesture to cause a song to be skipped by a song-providing API providing playback at, for example, a home speaker. An AR environment, as described herein, includes, but is not limited to, VR environments (including non-immersive, semi-immersive, and fully immersive VR environments); augmented-reality environments (including marker-based augmented-reality environments, markerless augmented-reality environments, location-based augmented-reality environments, and projection-based augmented-reality environments); hybrid reality; and other types of mixed-reality environments.

Artificial-reality content can include completely generated content or generated content combined with captured (e.g., real-world) content. The artificial-reality content can include video, audio, haptic events, or some combination thereof, any of which can be presented in a single channel or in multiple channels (such as stereo video that produces a three-dimensional effect to a viewer). Additionally, in some embodiments, artificial reality can also be associated with applications, products, accessories, services, or some combination thereof, which are used, for example, to create content in an artificial reality and/or are otherwise used in (e.g., to perform activities in) an artificial reality.

A hand gesture, as described herein, can include an in-air gesture, a surface-contact gesture, and or other gestures that can be detected and determined based on movements of a single hand (e.g., a one-handed gesture performed with a user's hand that is detected by one or more sensors of a wearable device (e.g., electromyography (EMG) and/or inertial measurement units (IMU) s of a wrist-wearable device) and/or detected via image data captured by an imaging device of a wearable device (e.g., a camera of a head-wearable device)) or a combination of the user's hands. In-air means, in some embodiments, that the user hand does not contact a surface, object, or portion of an electronic device (e.g., a head-wearable device or other communicatively coupled device, such as the wrist-wearable device), in other words the gesture is performed in open air in 3D space and without contacting a surface, an object, or an electronic device. Surface-contact gestures (contacts at a surface, object, body part of the user, or electronic device) more generally are also contemplated in which a contact (or an intention to contact) is detected at a surface (e.g., a single or double finger tap on a table, on a user's hand or another finger, on the user's leg, a couch, a steering wheel, etc.). The different hand gestures disclosed herein can be detected using image data and/or sensor data (e.g., neuromuscular signals sensed by one or more biopotential sensors (e.g., EMG sensors) or other types of data from other sensors, such as proximity sensors, time-of-flight (ToF) sensors, sensors of an inertial measurement unit, etc.) detected by a wearable device worn by the user and/or other electronic devices in the user's possession (e.g., smartphones, laptops, imaging devices, intermediary devices, and/or other devices described herein).

The devices described herein include extended-reality headsets for use in extended-reality systems (such as augmented-reality systems and/or virtual-reality systems) and joints and/or hinges that connect the arms of the extended-reality headsets to the main bodies of the extended-reality headsets. The joints (also referred to as joint assemblies) include a concentric ring design, wherein two rigid rings connected to the arms and the main bodies of the extended-reality headsets are connected by a flexible ring. The flexible connecting ring allows the arms and the main bodies of the extended-reality headsets to move relative to each other. This relative movement allows the extended-reality headsets to fit on the heads of users in different orientations, which accommodates different head shapes and sizes. The joints described herein have a compact design that allows the extended-reality headsets to fit on a wider range of head sizes and head shapes.

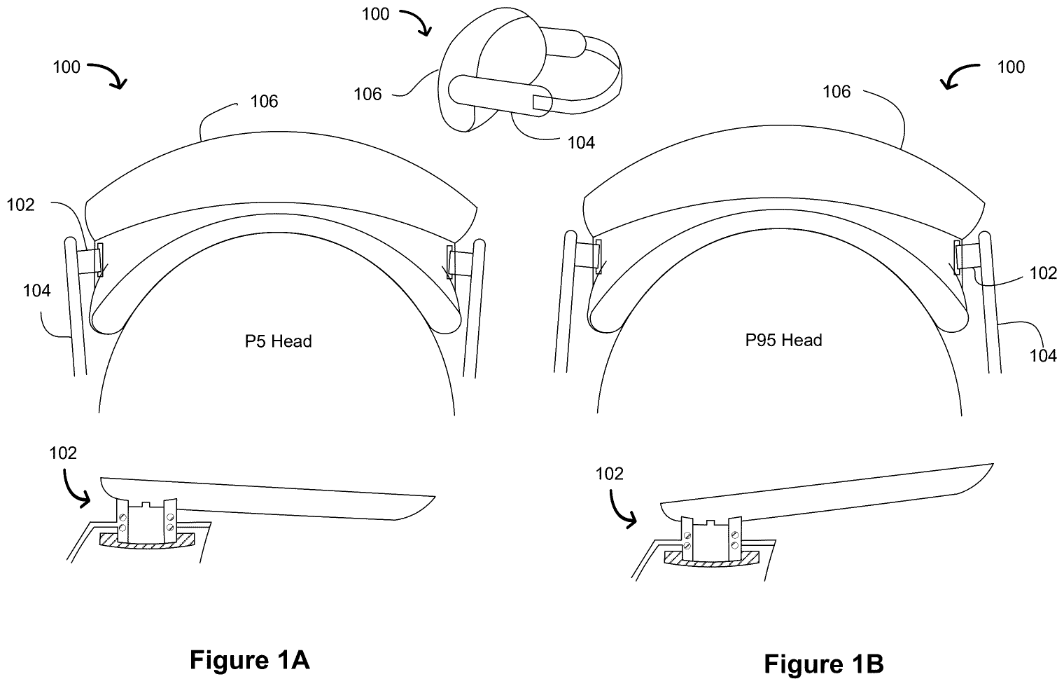

FIG. 1A illustrates an extended-reality headset 100 with the joint assembly 102 of the extended-reality headset 100 positioned to fit a wearer with a head size in the fifth percentile, in accordance with some embodiments. The extended-reality (e.g., a virtual-reality or augmented-reality) headset 100 (also referred to as a head-worn device or a head-mounted device) includes a joint assembly 102 that connects the arms 104 (also referred to as temple arms or straps) of the extended-reality headset 100 to the main body 106 of the extended-reality headset 100.

The joint assembly 102 has different orientations when the extended-reality headset 100 is worn by wearers with heads of different sizes because the joint assembly 102 enables the arms 104 and the main body 106 move in multiple degrees of freedom to fit comfortably on the wearer's head. For example, as shown in FIG. 1A, on a wearer with a head size in the fifth percentile, the arms 104 are pivoted inwards towards the head of the wearer in order to fit a smaller head. The arms 104 can achieve this first degree of freedom (also referred to as the yaw movement) because the joint assembly 102 is configured to movably couple the arms 104 to the main body 106.

FIG. 1B illustrates an extended-reality headset 100 with the joint assembly 102 of the extended-reality headset 100 positioned to fit a wearer with a head size in the ninety-fifth percentile, in accordance with some embodiments. In this orientation of the joint assembly 102, the arms 104 are pivoted outwards away from the head of the wearer in order to fit a larger head. Like the orientation shown in FIG. 1A, this orientation is an example of the yaw movement made possible by the joint assembly 102.

While FIGS. 1A and 1B are shown to accommodate user's with fifth percentile and ninety-fifth percentile head sizes, it is conceived that the extended reality headset can accommodate any head size between fifth percentile and ninety-fifth percentile head sizes. In addition, due to the nature of joint assembly having a stepless adjustment (e.g., due to its elastic construction), the joint assembly can be adjusted to the preferred location for any user who wears the headset.

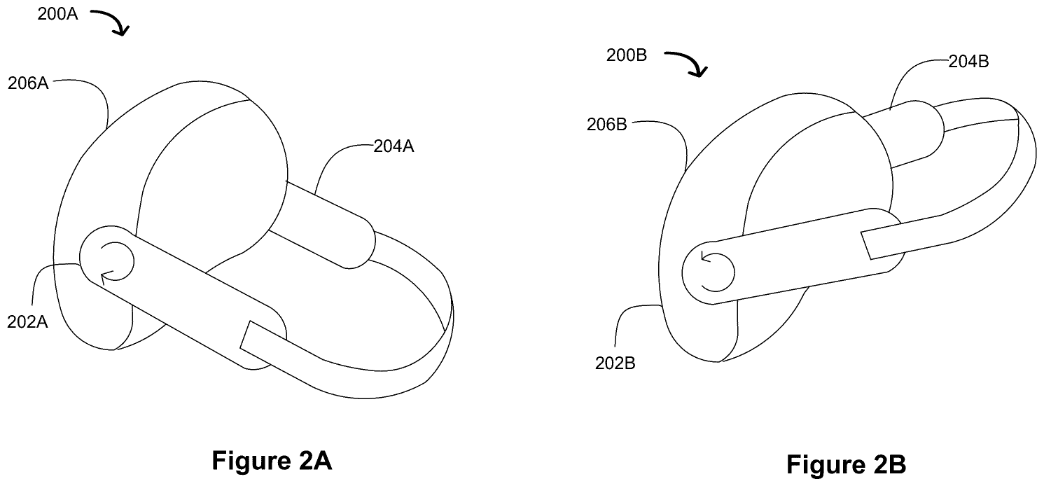

FIG. 2A illustrates an extended-reality headset 200A with the arms 204A rotating clockwise, in accordance with some embodiments. The extended-reality headset 200A includes a joint assembly 202A that connects the arms 204A of the extended-reality headset 200A to the main body 206A of the extended-reality headset 200A. As shown in FIG. 2A, the joint assembly 202A has different orientations when the extended-reality headset 200A is worn by wearers with heads of different sizes because the joint assembly 202A enables the arms 204A and the main body 206A to move in multiple degrees of freedom to fit comfortably on the wearer's head. As shown in FIG. 2A, the arms 204A can be rotated—for example, lower relative to the ears of the wearer and the main body 206A—to accommodate a wearer's head shape or head size. The arms 204A can achieve this second degree of freedom (also referred to as the pitch movement) because the joint assembly 202A is configured to movably couple the arms 204A to the main body 206A.

FIG. 2B illustrates an extended-reality headset 200B (equivalent to extended reality headset 200A shown in FIG. 2A) with the arms 204B rotating counter-clockwise, in accordance with some embodiments. FIG. 2B demonstrates that the arms 204B can also be rotated counter-clockwise (e.g., higher relative to the ears of the wearer and the main body 206B) to accommodate a greater range of head shapes and head sizes. Like the orientation shown in FIG. 2A, this orientation is an example of the pitch movement made possible by the joint assembly 202B.

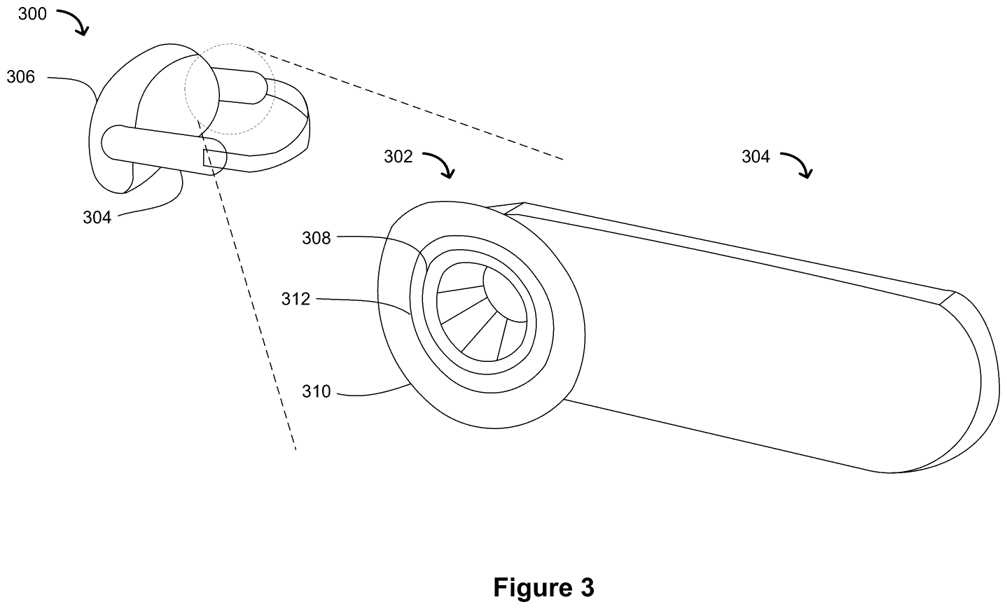

FIG. 3 illustrates the structure of the joint assembly 302, in accordance with some embodiments. The joint assembly 302 corresponds to the joint assembly 102 in FIGS. 1A and 1B and the joint assembly 202 in FIGS. 2A and 2B. The joint assembly 302 can include three primary components: a first ring 308 connected to the arms 304 of the extended-reality headset 300, a second ring 310 connected to the main body 306 of the extended-reality headset 300, and a connecting ring 312 that couples the first ring 308 to the second ring 310. In some embodiments, the first ring 308 is a central protrusion that is coupled to the arms 304 to form a neck or torque ring. In some embodiments, the second ring 310 is an outer ring that is coupled to the main body 306 and surrounds the central protrusion. In some embodiments, the connecting ring 312 is a concentric flexible portion. In some embodiments, the second ring 310 and the connecting ring 312 are integrally manufactured on the extended-reality headset 300. In some embodiments, the joint assembly 302 is fixed to the main body 306 of the extended-reality headset 300 by fastening the second ring 310 into the inner wall of the main body 306 (e.g., by using screws).

The first ring 308 and the second ring 310 are constructed from a first material, and the connecting ring 312 is constructed from a second material. The first material is more rigid than the second material. In some embodiments, the first material is plastic. In some embodiments, the first ring 308 and the second ring 312 are constructed from different materials. The second material is a flexible material that can compress and stretch while a wearer wears the extended-reality headset 300. In some embodiments, the flexible material is rubber. The rubber material provides some resistance to forces moving it and has the elasticity to return to its original position when the wearer doffs the extended-reality headset 300.

The flexible material of the connecting ring 312 allows the first ring 308 to move relative to the second ring 310 while the first ring 308 remains coupled to the second ring 310. Likewise, the flexible material of the connecting ring 312 allows the second ring 310 to move relative to the first ring 308 while the second ring 310 remains coupled to the first ring 308. In other words, the arms 304 can move relative to the main body 306, and vice versa, because the connecting ring 312 bends, compresses, and/or stretches while the arms 304 and the main body 306 move. In some embodiments, the first ring 308 and the second ring 310 are able to move independently of each other while still being connected because of the flexibility of the connecting ring 312.

In some embodiments, the size of the connecting ring 312 correlates to the amount of flexibility provided by the connecting ring. For example, a connecting ring 312 with a large thickness (e.g., beyond 5 mm of thickness at its largest width along a cross section of the connecting ring 312) allows greater relative movement between the arms 304 and the main body 306 than a connecting ring 312 with a small thickness. Similarly, a connecting ring 312 with a small width is less flexible, and thus allows less relative movement between the arms 304 and the main body 306, than a connecting ring 312 with a large width.

Because of the flexibility of the connecting ring 312, the arms 304 can move relative to the main body 306 (and vice versa) along at least two different degrees of freedom. In some embodiments, the first degree of freedom is a yaw movement (as shown in FIGS. 1A and 1B). The main body 306 rests on the wearer's face, and the flexibility of the connecting ring 312 allows the arms 304 to rotate towards or away from the head of the wearer, depending on the head shape or head size of the wearer. In some embodiments, the second degree of freedom is a pitch movement (as shown in FIGS. 2A and 2B). The main body 306 rests on the wearer's face, and the flexibility of the connecting ring allows the arms 304 to rotate up and down relative to the ears of the wearer to accommodate different head shapes and sizes. In some embodiments, the joint assembly 302 allows simultaneous movement in both of the at least two degrees of freedom. In some embodiments, the joint assembly 302 allows movement in a third degree of freedom. In some embodiments, the third degree of freedom is a roll movement.

The concentric ring design of the joint assembly 302 provides the arms 304 of an extended-reality headset 300 with a wider range of orientations than traditional joints of glasses, goggles, and/or headsets. This wider range of orientations makes it possible for wearers with a wider range of head sizes (e.g., wearers with head sizes in the fifth percentile and the ninety-fifth percentile) to experience the same level of comfort while wearing an extended-reality headset 300 as wearers with more average head sizes. Additionally, the concentric ring design of the joint assembly 302 allows this wider range of orientations in a compact design that does not significantly increase the weight or size of an extended-reality headset 300 (as compared to an extended-reality headset 300 with a traditional joint). The concentric ring design of the joint assembly 302 also minimizes the size and part count of the joint assembly 302. In some embodiment, the joint assembly is manufactured using a double shot injection molding process.

(A1) In accordance with some embodiments, an extended-reality headset comprises a joint assembly that includes a first ring (made of a rigid material—e.g., plastic such as ABS, polycarbonate, etc.) connected to an arm of the extended-reality headset (e.g., FIG. 3 shows that the first ring 308 is connected to arm 304). The joint assembly also includes a second ring (made of a rigid material—e.g., the same plastic material as the first ring or a different plastic material) connected to a main body of the extended-reality headset (e.g., the second ring 310 in FIG. 3 can be connected to the main body 306). The joint assembly also includes a connecting ring that couples the first ring to the second ring (e.g., FIG. 3 shows that the connecting ring 312 couples the first ring 308 to the second ring 310). The connecting ring comprises a flexible material (e.g., rubber) such that the first ring and the second ring can remain coupled and move relative to each other, and the connecting ring is configured to enable movement along a first degree of freedom (e.g., a yaw movement as shown in FIGS. 1A and 1B) of the arm of the extended-reality headset relative to the main body of the extended reality headset, and the connecting ring is configured to enable movement along a second degree of freedom (e.g., a pitch movement, as shown in FIGS. 2A and 2B) of the arm of the extended reality headset relative to the main body of the extended reality headset. In some embodiments, the first degree of freedom is different from the second degree of freedom.

(A2) In some embodiments of A1, the joint assembly is configured to have a first orientation when donned upon a first-sized head (e.g., the fifth percentile head shown in FIG. 1A). In some embodiments, the first orientation includes a first measurement along the first degree of freedom (e.g., FIG. 1A shows the arms 104 pivoted inwards toward the wearer's head to fit properly on a smaller head) and a first measurement along the second degree of freedom (e.g., FIG. 2A shows the arms 204 rotated lower relative to the ears of the wearer and the main body 206). The joint assembly is also configured to have a second orientation when donned upon second-sized head (e.g., the ninety-fifth percentile head shown in FIG. 1B), that is different in size than the first-sized head. In some embodiments, the second orientation includes a second measurement along the first degree of freedom (e.g., FIG. 1B shows the arms 104 pivoted outwards away from the wearer's head to fit properly on a larger head) and a second measurement along the second degree of freedom (e.g., FIG. 2B shows the arms 204 rotated higher relative to the ears of the wearer and the main body 206).

(A3) In some embodiments of any of A1-A2, the first ring and the second ring are constructed of a first material that is more rigid than a second material of the connecting ring, such that the second material can compress and stretch while being worn by a wearer (e.g., FIGS. 1A-2B show that the arms 104, 204 move in at least two degrees of freedom to fit properly on the head of a wearer).

(A4) In some embodiments of any of A1-A3, the connecting ring is constructed of rubber.

(A5) In some embodiments of any of A1-A4, the first ring and the second ring are constructed of plastic.

(B1) In accordance with some embodiments, a hinge for an extended-reality headset, where the extended-reality headset is configured in accordance with any of A1-A5.

(C1) In accordance with some embodiments, an extended-reality system that includes an extended-reality headset, where the extended-reality headset is configured in accordance with any of A1-A5.

The devices described above are further detailed below, including systems, wrist-wearable devices, headset devices, and smart textile-based garments. Specific operations described above may occur as a result of specific hardware, such hardware is described in further detail below. The devices described below are not limiting and features on these devices can be removed or additional features can be added to these devices. The different devices can include one or more analogous hardware components. For brevity, analogous devices and components are described below. Any differences in the devices and components are described below in their respective sections.

As described herein, a processor (e.g., a central processing unit (CPU) or microcontroller unit (MCU)), is an electronic component that is responsible for executing instructions and controlling the operation of an electronic device. There are various types of processors that may be used interchangeably or specifically required by embodiments described herein. For example, a processor may be (i) a general processor designed to perform a wide range of tasks, such as running software applications, managing operating systems, and performing arithmetic and logical operations; (ii) a microcontroller designed for specific tasks such as controlling electronic devices, sensors, and motors; (iii) a graphics processing unit (GPU) designed to accelerate the creation and rendering of images, videos, and animations (e.g., virtual-reality animations, such as three-dimensional modeling); (iv) a field-programmable gate array (FPGA) that can be programmed and reconfigured after manufacturing and/or customized to perform specific tasks, such as signal processing, cryptography, and machine learning; (v) a digital signal processor (DSP) designed to perform mathematical operations on signals such as audio, video, and radio waves. One of skill in the art will understand that one or more processors of one or more electronic devices may be used in various embodiments described herein.

As described herein, controllers are electronic components that manage and coordinate the operation of other components within an electronic device (e.g., controlling inputs, processing data, and/or generating outputs). Examples of controllers can include (i) microcontrollers, including small, low-power controllers that are commonly used in embedded systems and Internet of Things (IoT) devices; (ii) programmable logic controllers (PLCs) that may be configured to be used in industrial automation systems to control and monitor manufacturing processes; (iii) system-on-a-chip (SoC) controllers that integrate multiple components such as processors, memory, I/O interfaces, and other peripherals into a single chip; and/or DSPs. As described herein, a graphics module is a component or software module that is designed to handle graphical operations and/or processes, and can include a hardware module and/or a software module.

As described herein, memory refers to electronic components in a computer or electronic device that store data and instructions for the processor to access and manipulate. The devices described herein can include volatile and non-volatile memory. Examples of memory can include (i) random access memory (RAM), such as DRAM, SRAM, DDR RAM or other random access solid state memory devices, configured to store data and instructions temporarily; (ii) read-only memory (ROM) configured to store data and instructions permanently (e.g., one or more portions of system firmware and/or boot loaders); (iii) flash memory, magnetic disk storage devices, optical disk storage devices, other non-volatile solid state storage devices, which can be configured to store data in electronic devices (e.g., universal serial bus (USB) drives, memory cards, and/or solid-state drives (SSDs)); and (iv) cache memory configured to temporarily store frequently accessed data and instructions. Memory, as described herein, can include structured data (e.g., SQL databases, MongoDB databases, GraphQL data, or JSON data). Other examples of memory can include: (i) profile data, including user account data, user settings, and/or other user data stored by the user; (ii) sensor data detected and/or otherwise obtained by one or more sensors; (iii) media content data including stored image data, audio data, documents, and the like; (iv) application data, which can include data collected and/or otherwise obtained and stored during use of an application; and/or any other types of data described herein.

As described herein, a power system of an electronic device is configured to convert incoming electrical power into a form that can be used to operate the device. A power system can include various components, including (i) a power source, which can be an alternating current (AC) adapter or a direct current (DC) adapter power supply; (ii) a charger input that can be configured to use a wired and/or wireless connection (which may be part of a peripheral interface, such as a USB, micro-USB interface, near-field magnetic coupling, magnetic inductive and magnetic resonance charging, and/or radio frequency (RF) charging); (iii) a power-management integrated circuit, configured to distribute power to various components of the device and ensure that the device operates within safe limits (e.g., regulating voltage, controlling current flow, and/or managing heat dissipation); and/or (iv) a battery configured to store power to provide usable power to components of one or more electronic devices.

As described herein, peripheral interfaces are electronic components (e.g., of electronic devices) that allow electronic devices to communicate with other devices or peripherals and can provide a means for input and output of data and signals. Examples of peripheral interfaces can include (i) USB and/or micro-USB interfaces configured for connecting devices to an electronic device; (ii) Bluetooth interfaces configured to allow devices to communicate with each other, including Bluetooth low energy (BLE); (iii) near-field communication (NFC) interfaces configured to be short-range wireless interfaces for operations such as access control; (iv) POGO pins, which may be small, spring-loaded pins configured to provide a charging interface; (v) wireless charging interfaces; (vi) global-position system (GPS) interfaces; (vii) Wi-Fi interfaces for providing a connection between a device and a wireless network; and (viii) sensor interfaces.

As described herein, sensors are electronic components (e.g., in and/or otherwise in electronic communication with electronic devices, such as wearable devices) configured to detect physical and environmental changes and generate electrical signals. Examples of sensors can include (i) imaging sensors for collecting imaging data (e.g., including one or more cameras disposed on a respective electronic device); (ii) biopotential-signal sensors; (iii) inertial measurement unit (e.g., IMUs) for detecting, for example, angular rate, force, magnetic field, and/or changes in acceleration; (iv) heart rate sensors for measuring a user's heart rate; (v) SpO2 sensors for measuring blood oxygen saturation and/or other biometric data of a user; (vi) capacitive sensors for detecting changes in potential at a portion of a user's body (e.g., a sensor-skin interface) and/or the proximity of other devices or objects; and (vii) light sensors (e.g., ToF sensors, infrared light sensors, or visible light sensors), and/or sensors for sensing data from the user or the user's environment. As described herein biopotential-signal-sensing components are devices used to measure electrical activity within the body (e.g., biopotential-signal sensors). Some types of biopotential-signal sensors include: (i) electroencephalography (EEG) sensors configured to measure electrical activity in the brain to diagnose neurological disorders; (ii) electrocardiogram EKG) sensors configured to measure electrical activity of the heart to diagnose heart problems; (iii) electromyography (EMG) sensors configured to measure the electrical activity of muscles and diagnose neuromuscular disorders; (iv) electrooculography (EOG) sensors configured to measure the electrical activity of eye muscles to detect eye movement and diagnose eye disorders.

As described herein, an application stored in memory of an electronic device (e.g., software) includes instructions stored in the memory. Examples of such applications include (i) games; (ii) word processors; (iii) messaging applications; (iv) media-streaming applications; (v) financial applications; (vi) calendars; (vii) clocks; (viii) web browsers; (ix) social media applications, (x) camera applications, (xi) web-based applications; (xii) health applications; (xiii) artificial-reality (AR) applications, and/or any other applications that can be stored in memory. The applications can operate in conjunction with data and/or one or more components of a device or communicatively coupled devices to perform one or more operations and/or functions.

As described herein, communication interface modules can include hardware and/or software capable of data communications using any of a variety of custom or standard wireless protocols (e.g., IEEE 802.15.4, Wi-Fi, ZigBee, 6LoWPAN, Thread, Z-Wave, Bluetooth Smart, ISA100.11a, WirelessHART, or MiWi), custom or standard wired protocols (e.g., Ethernet or HomePlug), and/or any other suitable communication protocol, including communication protocols not yet developed as of the filing date of this document. A communication interface is a mechanism that enables different systems or devices to exchange information and data with each other, including hardware, software, or a combination of both hardware and software. For example, a communication interface can refer to a physical connector and/or port on a device that enables communication with other devices (e.g., USB, Ethernet, HDMI, or Bluetooth). In some embodiments, a communication interface can refer to a software layer that enables different software programs to communicate with each other (e.g., application programming interfaces (APIs) and protocols such as HTTP and TCP/IP).

As described herein, a graphics module is a component or software module that is designed to handle graphical operations and/or processes, and can include a hardware module and/or a software module.

As described herein, non-transitory computer-readable storage media are physical devices or storage medium that can be used to store electronic data in a non-transitory form (e.g., such that the data is stored permanently until it is intentionally deleted or modified).

### Example AR Systems

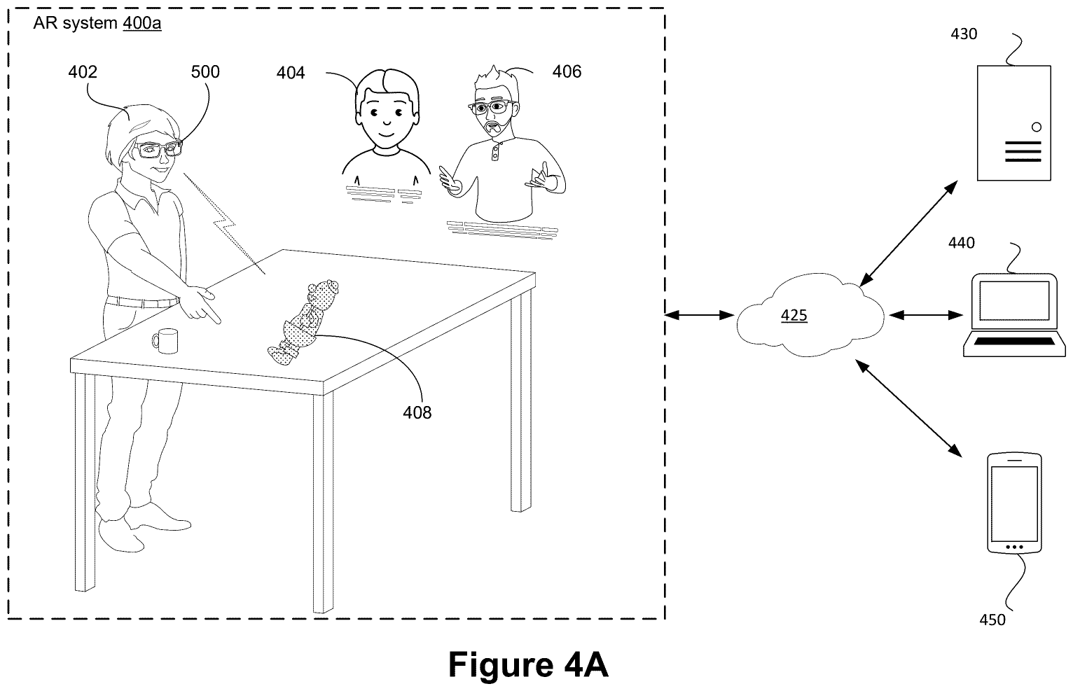

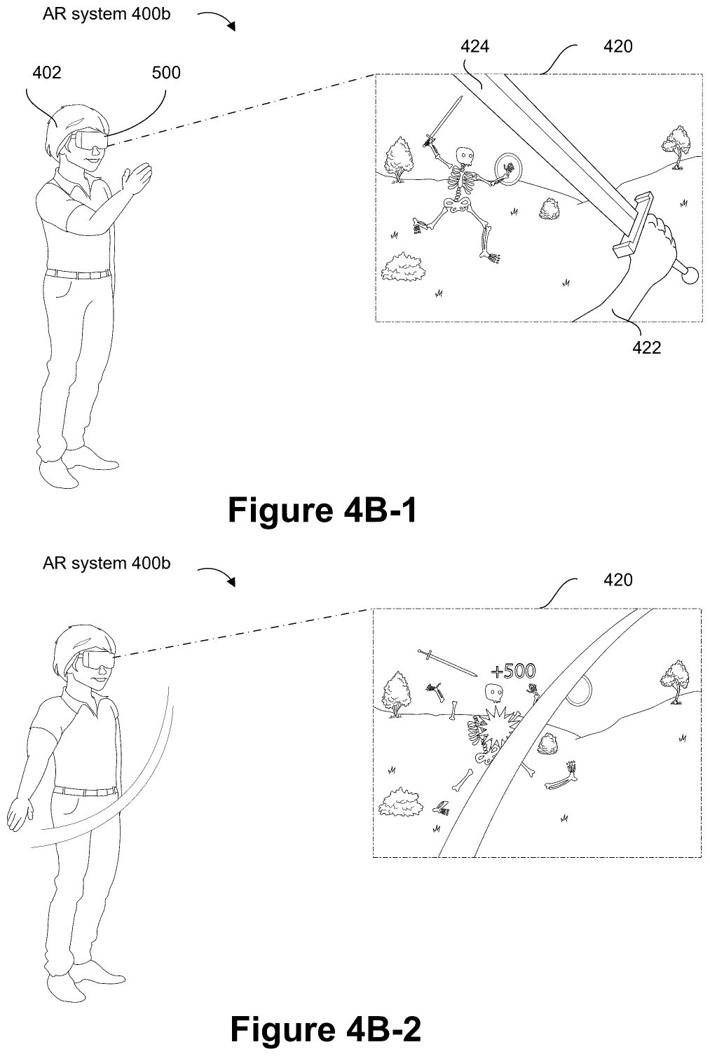

FIGS. 4A, 4B-1, and 4B-2 illustrate example artificial-reality systems, in accordance with some embodiments. FIG. 4A shows a first AR system 400a and first example user interactions using a head-wearable device (e.g., AR device 500). FIGS. 4B-1 and 4B-2 show a third AR system 400c and third example user interactions using a head-wearable device (e.g., virtual-reality (VR) device 510). As the skilled artisan will appreciate upon reading the descriptions provided herein, the above-example AR systems (described in detail below) can perform various functions and/or operations described above with reference to FIGS. 1-3.

Turning to FIG. 4A, a user 402 is shown wearing the AR device 500. The the AR device 500 facilitates user interaction with an AR environment. In particular, as shown by the first AR system 400a, the AR device 500 causes presentation of one or more avatars 404, digital representations of contacts 406, and virtual objects 408. As discussed below, the user 402 can interact with the one or more avatars 404, digital representations of the contacts 406, and virtual objects 408 via the AR device 500.

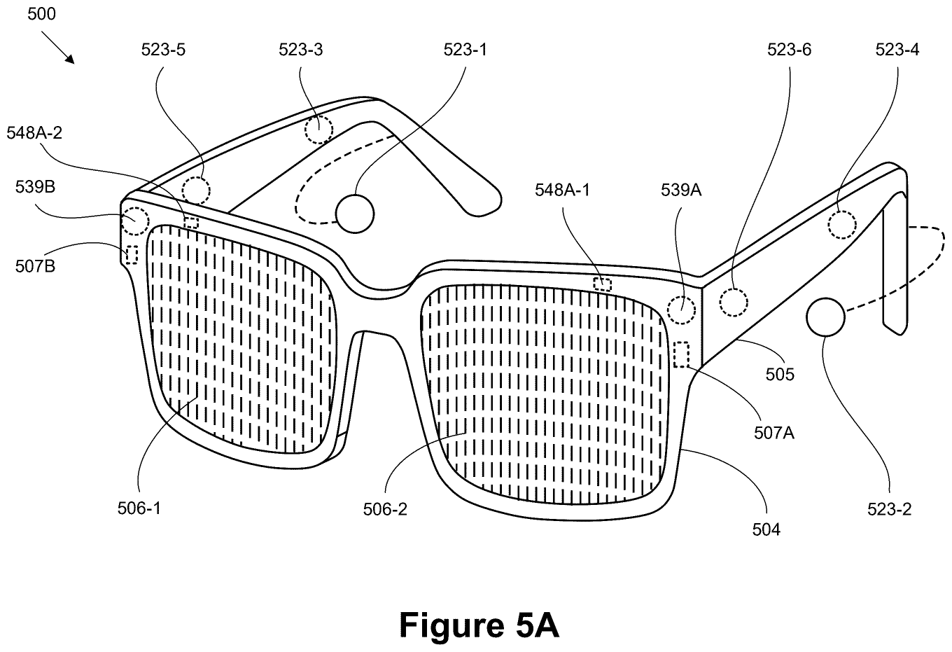

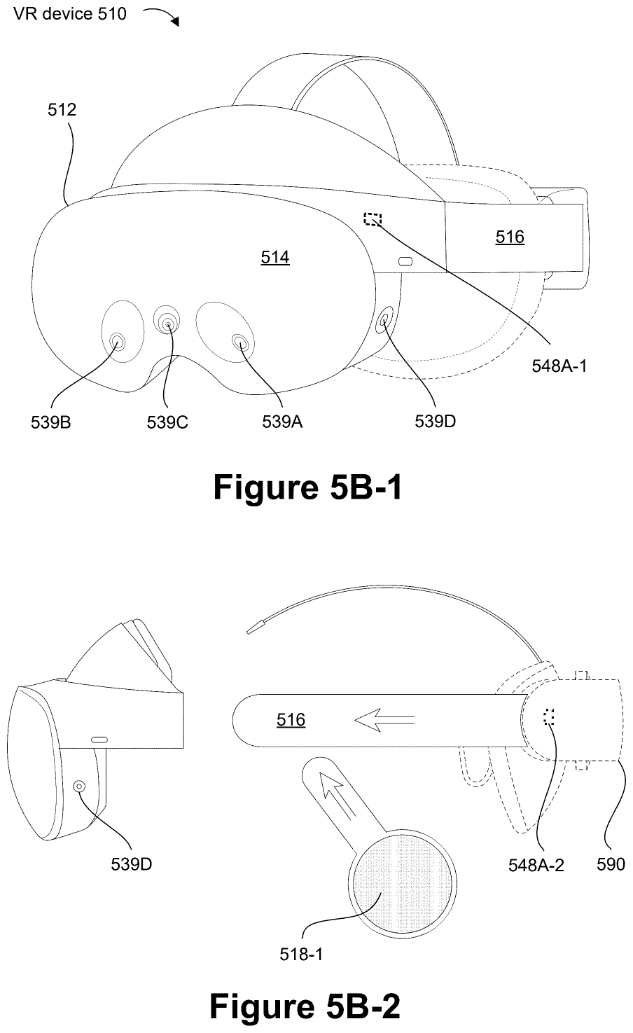

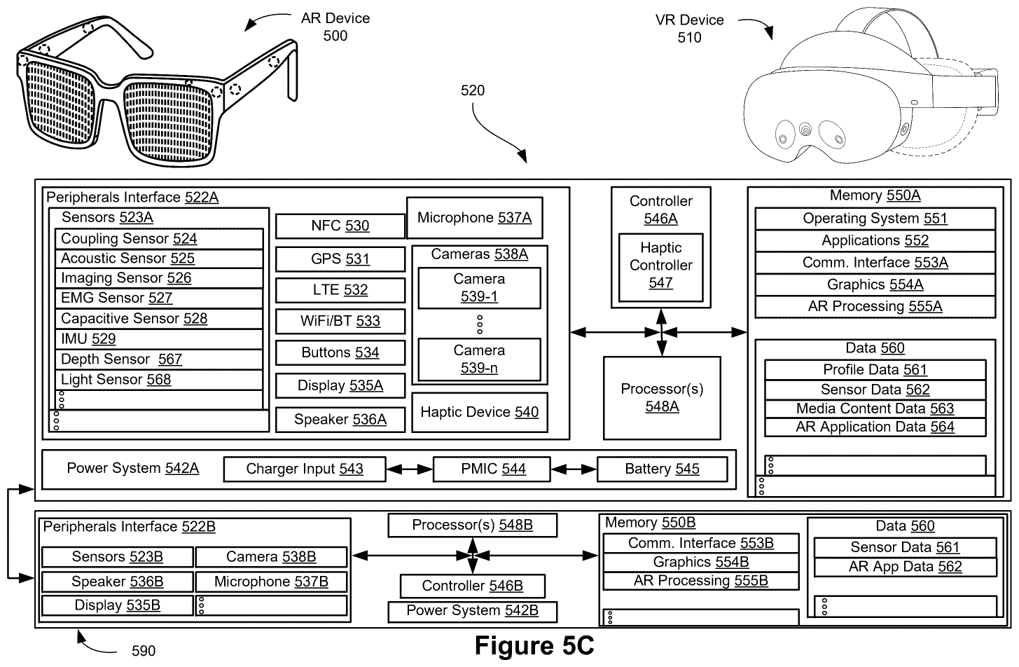

The user 402 can use the AR device 500 to provide user inputs. For example, the user 402 can perform one or more hand gestures that are detected by the AR device 500 (e.g., using one or more image sensors or cameras, described below in reference to FIGS. 5A-5B) to provide a user input. In some embodiments, the AR device 500 includes a digital assistant to help the user in providing a user input (e.g., completing a sequence of operations, suggesting different operations or commands, providing reminders, confirming a command). In some embodiments, the user 402 can provide a user input via one or more facial gestures and/or facial expressions. For example, cameras of the AR device 500 can track the user 402's eyes for navigating a user interface.

Turning to FIGS. 4B-1 and 4B-2, the user 402 is shown wearing a VR device 510. In the third AR system 400c, the VR device 510 is used to interact within an AR environment, such as a VR game or other AR application. While the VR device 510 presents a representation of a VR game (e.g., first AR game environment 420) to the user 402, the VR device 510 detects and coordinates one or more user inputs to allow the user 402 to interact with the VR game.

In some embodiments, the user 402 can provide a user input via the VR device 510 that causes an action in a corresponding AR environment. For example, the user 402 in the third AR system 400c (shown in FIG. 4B-1) raises his or her arm to prepare for a swing in the first AR game environment 420. The VR device 510, responsive to the user 402 raising his or her arm, causes the AR representation of the user 422 to perform a similar action (e.g., raise a virtual object, such as a virtual sword 424). In some embodiments, each device uses respective sensor data and/or image data to detect the user input and provide an accurate representation of the user 402's motion. For example, sensor data from the VR device 510 can be used to detect a velocity at which the user 402 raises his or her hand such that the AR representation of the user 422 and the virtual sword 424 are synchronized with the user 402's movements; and image sensors 526 (FIGS. 5A-5C) of the VR device 510 can be used to represent the user 402's body, boundary conditions, or real-world objects within the first AR game environment 420.

In FIG. 4B-2, the user 402 performs a downward swing. The user 402's downward swing is detected by the VR device 510 and a corresponding action is performed in the first AR game environment 420. In some embodiments, the data captured by each device is used to improve the user's experience within the AR environment. For example, sensor data of the VR device 510 can be used to determine a speed and/or force at which the downward swing is performed and image sensors of the VR device 510 can be used to determine a location of the swing and how it should be represented in the first AR game environment 420, which, in turn, can be used as inputs for the AR environment (e.g., game mechanics, which can use detected speed, force, locations, and/or aspects of the user 402's actions to classify a user's inputs (e.g., user performs a light strike, hard strike, critical strike, glancing strike, miss) or calculate an output (e.g., amount of damage)).

Having discussed example AR systems, devices for interacting with such AR systems, and other computing systems more generally, will now be discussed in greater detail below. Some definitions of devices and components that can be included in some or all of the example devices discussed below are defined here for ease of reference. A skilled artisan will appreciate that certain types of the components described below may be more suitable for a particular set of devices, and less suitable for a different set of devices. But subsequent reference to the components defined here should be considered to be encompassed by the definitions provided.

In some embodiments discussed below example devices and systems, including electronic devices and systems, will be discussed. Such example devices and systems are not intended to be limiting, and one of skill in the art will understand that alternative devices and systems to the example devices and systems described herein may be used to perform the operations and construct the systems and device that are described herein.

As described herein, an electronic device is a device that uses electrical energy to perform a specific function. It can be any physical object that contains electronic components such as transistors, resistors, capacitors, diodes, and integrated circuits. Examples of electronic devices include smartphones, laptops, digital cameras, televisions, gaming consoles, and music players, as well as the example electronic devices discussed herein. As described herein, an intermediary electronic device is a device that sits between two other electronic devices, and/or a subset of components of one or more electronic devices and facilitates communication, and/or data processing and/or data transfer between the respective electronic devices and/or electronic components.

### Example Head-Wearable Devices

FIGS. 5A, 5B-1, 5B-2, and 5C show example head-wearable devices, in accordance with some embodiments. Head-wearable devices can include, but are not limited to, AR devices 510 (e.g., AR or smart eyewear devices, such as smart glasses, smart monocles, smart contacts, etc.), VR devices 510 (e.g., VR headsets, head-mounted displays (HMD) s, etc.), or other ocularly coupled devices. The AR devices 500 and the VR devices 510 are instances of the head-wearable devices 100, 200, and 300 described in reference to FIGS. 1-3 herein, such that the head-wearable device should be understood to have the features of the AR devices 500 and/or the VR devices 510, and vice versa. The AR devices 500 and the VR devices 510 can perform various functions and/or operations associated with navigating through user interfaces and selectively opening applications, as well as the functions and/or operations described above with reference to FIGS. 1-3.

In some embodiments, an AR system (e.g., AR systems 400a-400d; FIGS. 4A-4D-2) includes an AR device 500 (as shown in FIG. 5A) and/or VR device 510 (as shown in FIGS. 5B-1-B-2). In some embodiments, the AR device 500 and the VR device 510 can include one or more analogous components (e.g., components for presenting interactive artificial-reality environments, such as processors, memory, and/or presentation devices, including one or more displays and/or one or more waveguides), some of which are described in more detail with respect to FIG. 5C. The head-wearable devices can use display projectors (e.g., display projector assemblies 507A and 507B) and/or waveguides for projecting representations of data to a user. Some embodiments of head-wearable devices do not include displays.

FIG. 5A shows an example visual depiction of the AR device 500 (e.g., which may also be described herein as augmented-reality glasses and/or smart glasses). The AR device 500 can work in conjunction with additional electronic components that are not shown in FIGS. 5A, such as a wearable accessory device and/or an intermediary processing device, in electronic communication or otherwise configured to be used in conjunction with the AR device 500. In some embodiments, the wearable accessory device and/or the intermediary processing device may be configured to couple with the AR device 500 via a coupling mechanism in electronic communication with a coupling sensor 524, where the coupling sensor 524 can detect when an electronic device becomes physically or electronically coupled with the AR device 500. In some embodiments, the AR device 500 can be configured to couple to a housing (e.g., a portion of frame 504 or temple arms 505), which may include one or more additional coupling mechanisms configured to couple with additional accessory devices. The components shown in FIG. 5A can be implemented in hardware, software, firmware, or a combination thereof, including one or more signal-processing components and/or application-specific integrated circuits (ASICs).

The AR device 500 includes mechanical glasses components, including a frame 504 configured to hold one or more lenses (e.g., one or both lenses 506-1 and 506-2). One of ordinary skill in the art will appreciate that the AR device 500 can include additional mechanical components, such as hinges configured to allow portions of the frame 504 of the AR device 500 to be folded and unfolded, a bridge configured to span the gap between the lenses 506-1 and 506-2 and rest on the user's nose, nose pads configured to rest on the bridge of the nose and provide support for the AR device 500, earpieces configured to rest on the user's ears and provide additional support for the AR device 500, temple arms 505 configured to extend from the hinges to the earpieces of the AR device 500, and the like. One of ordinary skill in the art will further appreciate that some examples of the AR device 500 can include none of the mechanical components described herein. For example, smart contact lenses configured to present artificial-reality to users may not include any components of the AR device 500.

The lenses 506-1 and 506-2 can be individual displays or display devices (e.g., a waveguide for projected representations). The lenses 506-1 and 506-2 may act together or independently to present an image or series of images to a user. In some embodiments, the lenses 506-1 and 506-2 can operate in conjunction with one or more display projector assemblies 507A and 507B to present image data to a user. While the AR device 500 includes two displays, embodiments of this disclosure may be implemented in AR devices with a single near-eye display (NED) or more than two NEDs.

The AR device 500 includes electronic components, many of which will be described in more detail below with respect to FIG. 5C. Some example electronic components are illustrated in FIG. 5A, including sensors 523-1, 523-2, 523-3, 523-4, 523-5, and 523-6, which can be distributed along a substantial portion of the frame 504 of the AR device 500. The different types of sensors are described below in reference to FIG. 5C. The AR device 500 also includes a left camera 539A and a right camera 539B, which are located on different sides of the frame 504. And the eyewear device includes one or more processors 548A and 548B (e.g., an integral microprocessor, such as an ASIC) that is embedded into a portion of the frame 504.

FIGS. 5B-1 and 5B-2 show an example visual depiction of the VR device 510 (e.g., a head-mounted display (HMD) 512, also referred to herein as an artificial-reality headset, a head-wearable device, a VR headset, etc.). The HMD 512 includes a front body 514 and a frame 516 (e.g., a strap or band) shaped to fit around a user's head. In some embodiments, the front body 514 and/or the frame 516 includes one or more electronic elements for facilitating presentation of and/or interactions with an AR and/or VR system (e.g., displays, processors (e.g., processor 548A-1), IMUs, tracking emitter or detectors, sensors, etc.). In some embodiments, the HMD 512 includes output audio transducers (e.g., an audio transducer 518-1), as shown in FIG. 5B-2. In some embodiments, one or more components, such as the output audio transducer(s) 518-1 and the frame 516, can be configured to attach and detach (e.g., are detachably attachable) to the HMD 512 (e.g., a portion or all of the frame 516, and/or the output audio transducer 518-1), as shown in FIG. 5B-2. In some embodiments, coupling a detachable component to the HMD 512 causes the detachable component to come into electronic communication with the HMD 512. The VR device 510 includes electronic components, many of which will be described in more detail below with respect to FIG. 5C

FIG. 5B-1 to 5B-2 also show that the VR device 510 one or more cameras, such as the left camera 539A and the right camera 539B, which can be analogous to the left and right cameras on the frame 504 of the AR device 500. In some embodiments, the VR device 510 includes one or more additional cameras (e.g., cameras 539C and 539D), which can be configured to augment image data obtained by the cameras 539A and 539B by providing more information. For example, the camera 539C can be used to supply color information that is not discerned by cameras 539A and 539B. In some embodiments, one or more of the cameras 539A to 539D can include an optional IR cut filter configured to remove IR light from being received at the respective camera sensors.

The VR device 510 can include a housing 590 storing one or more components of the VR device 510 and/or additional components of the VR device 510. The housing 590 can be a modular electronic device configured to couple with the VR device 510 (or an AR device 500) and supplement and/or extend the capabilities of the VR device 510 (or an AR device 500). For example, the housing 590 can include additional sensors, cameras, power sources, processors (e.g., processor 548A-2), etc. to improve and/or increase the functionality of the VR device 510. Examples of the different components included in the housing 590 are described below in reference to FIG. 5C.

Alternatively or in addition, in some embodiments, the head-wearable device, such as the VR device 510 and/or the AR device 500), includes, or is communicatively coupled to, another external device (e.g., a paired device), such as an optional neckband. The optional neckband can couple to the head-wearable device via one or more connectors (e.g., wired or wireless connectors). The head-wearable device and the neckband can operate independently without any wired or wireless connection between them. In some embodiments, the components of the head-wearable device and the neckband are located on one or more additional peripheral devices paired with the head-wearable device, the neckband, or some combination thereof. Furthermore, the neckband is intended to represent any suitable type or form of paired device. Thus, the following discussion of neckband may also apply to various other paired devices, such as smart watches, smart phones, wrist bands, other wearable devices, hand-held controllers, tablet computers, or laptop computers.

In some situations, pairing external devices, such as an intermediary processing device (e.g., an optional neckband and/or wearable accessory device) with the head-wearable devices (e.g., an AR device 500 and/or VR device 510) enables the head-wearable devices to achieve a similar form factor of a pair of glasses while still providing sufficient battery and computation power for expanded capabilities. Some, or all, of the battery power, computational resources, and/or additional features of the head-wearable devices can be provided by a paired device or shared between a paired device and the head-wearable devices, thus reducing the weight, heat profile, and form factor of the head-wearable devices overall while allowing the head-wearable devices to retain its desired functionality. For example, the intermediary processing device can allow components that would otherwise be included in a head-wearable device to be included in the intermediary processing device (and/or a wearable device or accessory device), thereby shifting a weight load from the user's head and neck to one or more other portions of the user's body. In some embodiments, the intermediary processing device has a larger surface area over which to diffuse and disperse heat to the ambient environment. Thus, the intermediary processing device can allow for greater battery and computation capacity than might otherwise have been possible on the head-wearable devices, standing alone. Because weight carried in the intermediary processing device can be less invasive to a user than weight carried in the head-wearable devices, a user may tolerate wearing a lighter eyewear device and carrying or wearing the paired device for greater lengths of time than the user would tolerate wearing a heavier eyewear device standing alone, thereby enabling an artificial-reality environment to be incorporated more fully into a user's day-to-day activities.

In some embodiments, the intermediary processing device is communicatively coupled with the head-wearable device and/or to other devices. The other devices may provide certain functions (e.g., tracking, localizing, depth mapping, processing, storage, etc.) to the head-wearable device. In some embodiments, the intermediary processing device includes a controller and a power source. In some embodiments, sensors of the intermediary processing device are configured to sense additional data that can be shared with the head-wearable devices in an electronic format (analog or digital).

The controller of the intermediary processing device processes information generated by the sensors on the intermediary processing device and/or the head-wearable devices. The intermediary processing device can process information generated by one or more sensors of its sensors and/or information provided by other communicatively coupled devices. For example, a head-wearable device can include an IMU, and the intermediary processing device (e.g., a neckband) can compute all inertial and spatial calculations from the IMUs located on the head-wearable device.

Artificial-reality systems may include a variety of types of visual feedback mechanisms. For example, display devices in the AR devices 500 and/or the VR devices 510 may include one or more liquid-crystal displays (LCDs), light emitting diode (LED) displays, organic LED (OLED) displays, and/or any other suitable type of display screen. Artificial-reality systems may include a single display screen for both eyes or may provide a display screen for each eye, which may allow for additional flexibility for varifocal adjustments or for correcting a refractive error associated with the user's vision. Some artificial-reality systems also include optical subsystems having one or more lenses (e.g., conventional concave or convex lenses, Fresnel lenses, or adjustable liquid lenses) through which a user may view a display screen. In addition to or instead of using display screens, some artificial-reality systems include one or more projection systems. For example, display devices in the AR device 500 and/or the VR device 510 may include micro-LED projectors that project light (e.g., using a waveguide) into display devices, such as clear combiner lenses that allow ambient light to pass through. The display devices may refract the projected light toward a user's pupil and may enable a user to simultaneously view both artificial-reality content and the real world. Artificial-reality systems may also be configured with any other suitable type or form of image projection system. As noted, some AR systems may, instead of blending an artificial reality with actual reality, substantially replace one or more of a user's sensory perceptions of the real world with a virtual experience.

While the example head-wearable devices are respectively described herein as the AR device 500 and the VR device 510, either or both of the example head-wearable devices described herein can be configured to present fully-immersive VR scenes presented in substantially all of a user's field of view, additionally or alternatively to, subtler augmented-reality scenes that are presented within a portion, less than all, of the user's field of view.

In some embodiments, the AR device 500 and/or the VR device 510 can include haptic feedback systems. The haptic feedback systems may provide various types of cutaneous feedback, including vibration, force, traction, shear, texture, and/or temperature. The haptic feedback systems may also provide various types of kinesthetic feedback, such as motion and compliance. The haptic feedback can be implemented using motors, piezoelectric actuators, fluidic systems, and/or a variety of other types of feedback mechanisms. The haptic feedback systems may be implemented independently of other artificial-reality devices, within other artificial-reality devices, and/or in conjunction with other artificial-reality devices (e.g., wrist-wearable devices which may be incorporated into headwear, gloves, body suits, handheld controllers, environmental devices (e.g., chairs or floormats), and/or any other type of device or system, such as a wrist-wearable device, a handheld intermediary processing device, smart textile-based garment, etc.), and/or other devices described herein.

FIG. 5C illustrates a computing system 520 and an optional housing 590, each of which show components that can be included in a head-wearable device (e.g., the AR device 500 and/or the VR device 510). In some embodiments, more or less components can be included in the optional housing 590 depending on practical restraints of the respective head-wearable device being described. Additionally or alternatively, the optional housing 590 can include additional components to expand and/or augment the functionality of a head-wearable device.

In some embodiments, the computing system 520 and/or the optional housing 590 can include one or more peripheral interfaces 522A and 522B, one or more power systems 542A and 542B (including charger input 543, PMIC 544, and battery 545), one or more controllers 546A 546B (including one or more haptic controllers 547), one or more processors 548A and 548B (as defined above, including any of the examples provided), and memory 550A and 550B, which can all be in electronic communication with each other. For example, the one or more processors 548A and/or 548B can be configured to execute instructions stored in the memory 550A and/or 550B, which can cause a controller of the one or more controllers 546A and/or 546B to cause operations to be performed at one or more peripheral devices of the peripherals interfaces 522A and/or 522B. In some embodiments, each operation described can occur based on electrical power provided by the power system 542A and/or 542B.

In some embodiments, the peripherals interface 522A can include one or more devices configured to be part of the computing system 520. For example, the peripherals interface can include one or more sensors 523A. Some example sensors include: one or more coupling sensors 524, one or more acoustic sensors 525, one or more imaging sensors 526, one or more EMG sensors 527, one or more capacitive sensors 528, and/or one or more IMUs 529. In some embodiments, the sensors 523A further include depth sensors 567, light sensors 568 and/or any other types of sensors defined above or described with respect to any other embodiments discussed herein.

In some embodiments, the peripherals interface can include one or more additional peripheral devices, including one or more NFC devices 530, one or more GPS devices 531, one or more LTE devices 532, one or more WiFi and/or Bluetooth devices 533, one or more buttons 534 (e.g., including buttons that are slidable or otherwise adjustable), one or more displays 535A, one or more speakers 536A, one or more microphones 537A, one or more cameras 538A (e.g., including the a first camera 539-1 through nth camera 539-n, which are analogous to the left camera 539A and/or the right camera 539B), one or more haptic devices 540; and/or any other types of peripheral devices defined above or described with respect to any other embodiments discussed herein.

The head-wearable devices can include a variety of types of visual feedback mechanisms (e.g., presentation devices). For example, display devices in the AR device 500 and/or the VR device 510 can include one or more liquid-crystal displays (LCDs), light emitting diode (LED) displays, organic LED (OLED) displays, micro-LEDs, and/or any other suitable types of display screens. The head-wearable devices can include a single display screen (e.g., configured to be seen by both eyes), and/or can provide separate display screens for each eye, which can allow for additional flexibility for varifocal adjustments and/or for correcting a refractive error associated with the user's vision. Some embodiments of the head-wearable devices also include optical subsystems having one or more lenses (e.g., conventional concave or convex lenses, Fresnel lenses, or adjustable liquid lenses) through which a user can view a display screen. For example, respective displays 535A can be coupled to each of the lenses 506-1 and 506-2 of the AR device 500. The displays 535A coupled to each of the lenses 506-1 and 506-2 can act together or independently to present an image or series of images to a user. In some embodiments, the AR device 500 and/or the VR device 510 includes a single display 535A (e.g., a near-eye display) or more than two displays 535A.

In some embodiments, a first set of one or more displays 535A can be used to present an augmented-reality environment, and a second set of one or more display devices 535A can be used to present a virtual-reality environment. In some embodiments, one or more waveguides are used in conjunction with presenting artificial-reality content to the user of the AR device 500 and/or the VR device 510 (e.g., as a means of delivering light from a display projector assembly and/or one or more displays 535A to the user's eyes). In some embodiments, one or more waveguides are fully or partially integrated into the AR device 500 and/or the VR device 510. Additionally, or alternatively to display screens, some artificial-reality systems include one or more projection systems. For example, display devices in the AR device 500 and/or the VR device 510 can include micro-LED projectors that project light (e.g., using a waveguide) into display devices, such as clear combiner lenses that allow ambient light to pass through. The display devices can refract the projected light toward a user's pupil and can enable a user to simultaneously view both artificial-reality content and the real world. The head-wearable devices can also be configured with any other suitable type or form of image projection system. In some embodiments, one or more waveguides are provided additionally or alternatively to the one or more display(s) 535A.

In some embodiments of the head-wearable devices, ambient light and/or a real-world live view (e.g., a live feed of the surrounding environment that a user would normally see) can be passed through a display element of a respective head-wearable device presenting aspects of the AR system. In some embodiments, ambient light and/or the real-world live view can be passed through a portion less than all, of an AR environment presented within a user's field of view (e.g., a portion of the AR environment co-located with a physical object in the user's real-world environment that is within a designated boundary (e.g., a guardian boundary) configured to be used by the user while they are interacting with the AR environment). For example, a visual user interface element (e.g., a notification user interface element) can be presented at the head-wearable devices, and an amount of ambient light and/or the real-world live view (e.g., 15-50% of the ambient light and/or the real-world live view) can be passed through the user interface element, such that the user can distinguish at least a portion of the physical environment over which the user interface element is being displayed.

The head-wearable devices can include one or more external displays 535A for presenting information to users. For example, an external display 535A can be used to show a current battery level, network activity (e.g., connected, disconnected, etc.), current activity (e.g., playing a game, in a call, in a meeting, watching a movie, etc.), and/or other relevant information. In some embodiments, the external displays 535A can be used to communicate with others. For example, a user of the head-wearable device can cause the external displays 535A to present a do not disturb notification. The external displays 535A can also be used by the user to share any information captured by the one or more components of the peripherals interface 522A and/or generated by head-wearable device (e.g., during operation and/or performance of one or more applications).

The memory 550A can include instructions and/or data executable by one or more processors 548A (and/or processors 548B of the housing 590) and/or a memory controller of the one or more controllers 546A (and/or controller 546B of the housing 590). The memory 550A can include one or more operating systems 551; one or more applications 552; one or more communication interface modules 553A; one or more graphics modules 554A; one or more AR processing modules 555A; and/or any other types of modules or components defined above or described with respect to any other embodiments discussed herein.

The data 560 stored in memory 550A can be used in conjunction with one or more of the applications and/or programs discussed above. The data 560 can include profile data 561; sensor data 562; media content data 563; AR application data 564; and/or any other types of data defined above or described with respect to any other embodiments discussed herein.

In some embodiments, the controller 546A of the head-wearable devices processes information generated by the sensors 523A on the head-wearable devices and/or another component of the head-wearable devices and/or communicatively coupled with the head-wearable devices (e.g., components of the housing 590, such as components of peripherals interface 522B). For example, the controller 546A can process information from the acoustic sensors 525 and/or image sensors 526. For each detected sound, the controller 546A can perform a direction of arrival (DOA) estimation to estimate a direction from which the detected sound arrived at a head-wearable device. As one or more of the acoustic sensors 525 detects sounds, the controller 546A can populate an audio data set with the information (e.g., represented by sensor data 562).

In some embodiments, a physical electronic connector can convey information between the head-wearable devices and another electronic device, and/or between one or more processors 548A of the head-wearable devices and the controller 546A. The information can be in the form of optical data, electrical data, wireless data, or any other transmittable data form. Moving the processing of information generated by the head-wearable devices to an intermediary processing device can reduce weight and heat in the eyewear device, making it more comfortable and safer for a user. In some embodiments, an optional accessory device (e.g., an electronic neckband) is coupled to the head-wearable devices via one or more connectors. The connectors can be wired or wireless connectors and can include electrical and/or non-electrical (e.g., structural) components. In some embodiments, the head-wearable devices and the accessory device can operate independently without any wired or wireless connection between them.

The head-wearable devices can include various types of computer vision components and subsystems. For example, the AR device 500 and/or the VR device 510 can include one or more optical sensors such as two-dimensional (2D) or three-dimensional (3D) cameras, time-of-flight depth sensors, single-beam or sweeping laser rangefinders, 3D LiDAR sensors, and/or any other suitable type or form of optical sensor. A head-wearable device can process data from one or more of these sensors to identify a location of a user and/or aspects of the use's real-world physical surroundings, including the locations of real-world objects within the real-world physical surroundings. In some embodiments, the methods described herein are used to map the real world, to provide a user with context about real-world surroundings, and/or to generate interactable virtual objects (which can be replicas or digital twins of real-world objects that can be interacted with in AR environment), among a variety of other functions. For example, FIGS. 5B-1 and 5B-2 show the VR device 510 having cameras 539A-539D, which can be used to provide depth information for creating a voxel field and a two-dimensional mesh to provide object information to the user to avoid collisions.

The optional housing 590 can include analogous components to those describe above with respect to the computing system 520. For example, the optional housing 590 can include a respective peripherals interface 522B including more or less components to those described above with respect to the peripherals interface 522A. As described above, the components of the optional housing 590 can be used augment and/or expand on the functionality of the head-wearable devices. For example, the optional housing 590 can include respective sensors 523B, speakers 536B, displays 535B, microphones 537B, cameras 538B, and/or other components to capture and/or present data. Similarly, the optional housing 590 can include one or more processors 548B, controllers 546B, and/or memory 550B (including respective communication interface modules 553B; one or more graphics modules 554B; one or more AR processing modules 555B, etc.) that can be used individually and/or in conjunction with the components of the computing system 520.

The techniques described above in FIGS. 5A-5C can be used with different head-wearable devices. In some embodiments, the head-wearable devices (e.g., the AR device 500 and/or the VR device 510) can be used in conjunction with one or more wearable device such as a wrist-wearable device (or components thereof) and/or a smart textile-based garment, as well as an handheld intermediary processing device.

Any data collection performed by the devices described herein and/or any devices configured to perform or cause the performance of the different embodiments described above in reference to any of the Figures, hereinafter the “devices,” is done with user consent and in a manner that is consistent with all applicable privacy laws. Users are given options to allow the devices to collect data, as well as the option to limit or deny collection of data by the devices. A user is able to opt-in or opt-out of any data collection at any time. Further, users are given the option to request the removal of any collected data.

It will be understood that, although the terms “first,” “second,” etc. may be used herein to describe various elements, these elements should not be limited by these terms. These terms are only used to distinguish one element from another.

The terminology used herein is for the purpose of describing particular embodiments only and is not intended to be limiting of the claims. As used in the description of the embodiments and the appended claims, the singular forms “a,” “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” can be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” can be construed to mean “upon determining” or “in response to determining” or “in accordance with a determination” or “upon detecting” or “in response to detecting” that the stated condition precedent is true, depending on the context.

The foregoing description, for purpose of explanation, has been described with reference to specific embodiments. However, the illustrative discussions above are not intended to be exhaustive or to limit the claims to the precise forms disclosed. Many modifications and variations are possible in view of the above teachings. The embodiments were chosen and described in order to best explain principles of operation and practical applications, to thereby enable others skilled in the art.

What is claimed is:

1. An extended-reality headset, comprising:
a joint assembly that includes:
a first ring connected to an arm of the extended-reality headset;
a second ring connected to a main body of the extended-reality headset; and
a connecting ring that couples the first ring to the second ring, wherein the connecting ring:
comprises a flexible material such that the first ring and the second ring can remain coupled and move relative to each other,
is configured to enable movement along a first degree of freedom of the arm of the extended-reality headset relative to the main body of the extended-reality headset, and
is configured to enable movement along a second degree of freedom of the arm of the extended-reality headset relative to the main body of the extended-reality headset, wherein the first degree of freedom is different from the second degree of freedom.

2. The extended-reality headset of claim 1, wherein the joint assembly is configured to:
have a first orientation when donned upon a first-sized head, wherein the first orientation includes a first measurement along the first degree of freedom and a first measurement along the second degree of freedom; and
have a second orientation when donned upon second-sized head, that is different in size than the first-sized head, wherein the second orientation includes a second measurement along the first degree of freedom and a second measurement along the second degree of freedom.

3. The extended-reality headset of claim 1, wherein the first ring and the second ring are constructed of a first material that is more rigid than a second material of the connecting ring, such that the second material can compress and stretch while being worn by a wearer.

4. The extended-reality headset of claim 1, wherein the connecting ring is constructed of rubber.

5. The extended-reality headset of claim 1, wherein the first ring and the second ring are constructed of plastic.

6. The extended-reality headset of claim 1, wherein the first degree of freedom allows for up to 90 degrees of movement and the second degree of freedom allows for up to 90 degrees of freedom.

7. The extended-reality headset of claim 1, wherein the joint assembly is configured to allow the extended-reality headset to be donned by persons having at least a 5th percentile to 95th percentile head size.

8. A hinge for an extended-reality headset, comprising:
a joint assembly that includes:
a first ring connected to an arm of the extended-reality headset;
a second ring connected to a main body of the extended-reality headset; and
a connecting ring that couples the first ring to the second ring, wherein the connecting ring:
comprises a flexible material such that the first ring and the second ring can remain coupled and move relative to each other,
is configured to enable movement along a first degree of freedom of the arm of the extended-reality headset relative to the main body of the extended-reality headset, and
is configured to enable movement along a second degree of freedom of the arm of the extended-reality headset relative to the main body of the extended-reality headset, wherein the first degree of freedom is different from the second degree of freedom.

9. The hinge for the extended-reality headset of claim 8, wherein the joint assembly is configured to:
have a first orientation when donned upon a first-sized head, wherein the first orientation includes a first measurement along the first degree of freedom and a first measurement along the second degree of freedom; and
have a second orientation when donned upon second-sized head, that is different in size than the first-sized head, wherein the second orientation includes a second measurement along the first degree of freedom and a second measurement along the second degree of freedom.

10. The hinge for the extended-reality headset of claim 8, wherein the first ring and the second ring are constructed of a first material that is more rigid than a second material of the connecting ring, such that the second material can compress and stretch while being worn by a wearer.

11. The hinge for the extended-reality headset of claim 8, wherein the connecting ring is constructed of rubber.

12. The hinge for the extended-reality headset of claim 8, wherein the first ring and the second ring are constructed of plastic.

13. The hinge of the extended-reality headset of claim 8, wherein the first degree of freedom allows for up to 90 degrees of movement and the second degree of freedom allows for up to 90 degrees of freedom.

14. The hinge of the extended-reality headset of claim 8, wherein the joint assembly is configured to allow the extended-reality headset to be donned by persons having at least a 5th percentile to 95th percentile head size.

15. An extended-reality system, comprising:
an extended-reality headset that includes a joint assembly that comprises:
a first ring connected to an arm of the extended-reality headset;
a second ring connected to a main body of the extended-reality headset; and
a connecting ring that couples the first ring to the second ring, wherein the connecting ring:
comprises a flexible material such that the first ring and the second ring can remain coupled and move relative to each other,
is configured to enable movement along a first degree of freedom of the arm of the extended-reality headset relative to the main body of the extended-reality headset, and
is configured to enable movement along a second degree of freedom of the arm of the extended-reality headset relative to the main body of the extended-reality headset, wherein the first degree of freedom is different from the second degree of freedom.

16. The extended-reality system of claim 15, wherein the joint assembly is configured to:
have a first orientation when donned upon a first-sized head, wherein the first orientation includes a first measurement along the first degree of freedom and a first measurement along the second degree of freedom; and
have a second orientation when donned upon second-sized head, that is different in size than the first-sized head, wherein the second orientation includes a second measurement along the first degree of freedom and a second measurement along the second degree of freedom.

17. The extended-reality system of claim 15, wherein the first ring and the second ring are constructed of a first material that is more rigid than a second material of the connecting ring, such that the second material can compress and stretch while being worn by a wearer.

18. The extended-reality system of claim 15, wherein the connecting ring is constructed of rubber.

19. The extended-reality system of claim 15, wherein the first ring and the second ring are constructed of plastic.

20. The extended-reality system of claim 15, wherein the first degree of freedom allows for up to 90 degrees of movement and the second degree of freedom allows for up to 90 degrees of freedom.
